(19) United States
(12) Patent Application Publication
(10) Pub. No.: US 2004/0103476 A1
(43) Pub. Date: Jun. 3, 2004

(54) Articulated bed frame

(75) Inventor: Isaac Barcesat, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hollandia International, Sederot (IL)

(21) Appl. No.: 09/974,736

(22) Filed: Oct. 9, 2001

(30) Foreign Application Priority Data
Oct. 12, 2000 (IL) 138,968

(51) Int. Cl. A61G 7/015

(52) U.S. Cl. 5/618; 5/617

(57) ABSTRACT

The invention provides an articulating bed frame, comprising a stationary base frame having a head end, a foot end, and opposed longitudinal members connecting the same, an articulated moving upper frame mounted on a carriage, having leg support portions and upper body support portions articulated to each other and supported on the carriage traveling in channels attached to the bed frame for longitudinal shifting of the support portions relative to the base frame and a mattress-supporting body attached to the upper frame, the mattress-supporting body being divided into at least a first portion including a body support sub-portion, a thigh support sub-portion and a lower leg support sub-portion, and a second head support portion, wherein the articulated movable frame is connected to linkages causing displacement of the head-support portion, at the neck area of the user, linearly and normal relative to the plane of the first portion.

The present invention relates to an articulating bed frame and to an adjustable bed incorporating the same. More particularly, the invention provides an articulated bed structure having an improved head support portion which automatically adjusts to a suitable position and slope as the body support portion of the bed is pivotally raised or lowered.

Beds in use in today's hospitals are usually adjustable so that the patient can be brought to a sitting position, or inclined between a sitting and lying position. Many beds also have provision for raising the foot section. Whichever mode is chosen depends on the patient's condition and doctor's recommendation Additional head support—if needed—is usually provided by adding a pillow. Bed configuration can be adjusted by lead screws operating a suitable mechanism. The outer end of the lead screw is usually fitted with a crank handle for manual operation. In modern models the lead screws are powered electrically.

In addition there is an increasing market for articulating and adjustable beds for private home use, wherein the bed can be changed from a horizontal orientation for sleep to a sitting position providing proper back and head support for reading, viewing television and other situations in which the user while still in bed does not wish to remain in a prone position.

The many improvements which have been proposed to adjustable beds have been detailed in numerous U.S. patents. The state of the art can best be gauged from the following review of the most recent patents published, these making reference to many earlier patents.

In U.S. Pat. No. 6,006,379 Hensley discloses a bed frame including a base frame and an articulated upper frame. The latter comprises an upper body section, a seat section, a thigh section and a lower leg section. A drive assembly is provided for raising the upper body section. There is no adjustable head section.

Allen in U.S. Pat. No. 6,058,532 discloses a lifting apparatus for raising either end of a bed frame.

Wu describes and claims a mechanized motor-driven foldable bed in U.S. Pat. Nos. 6,076,210, 6,101,649 and 6,108,839 intended to support the torso and legs of a patient. There is no separate headrest.

Foster in U.S. Pat. No. 6,112,345 discloses a hospital bed with a toilet module, which is revealed when the upper part of the bed is moved longitudinally. During such motion the configuration of the bed changes to bring the patient into a sitting position.

A feature which has not hitherto been given sufficient attention is the matter of head support. The use of a pillow or pillows is often unsatisfactory, particularly when the upper part of the bed is set at a slope. The pillow may not stay in place and some patients can not replace a pillow which has slipped out of position. Furthermore, a pillow does not offer any option except to raise the head of the patient. Should it be required to lower the patient's head or to support the head at a chosen angle, a pillow does not offer a solution.

In addition, in beds which are intended to be articulated between a horizontal and upright position numerous times for many years there exists the problem that when the back and head support portion of the mattress and mattress-supporting body are pivoted from a horizontal to an upright position there is a shifting between the two and proper support is not afforded to the upper end portion or the mattress which then protrudes above the upper end portion of the mattress-supporting body.

It is therefore one of the objects of the present invention to obviate the disadvantages of prior art adjustable beds and to provide an articulated upper frame having a separate headrest supported on a linkage responsive to the position of the torso support section.

It is a further object of the present invention to provide a bed frame which can be customized to accommodate users having different thigh lengths.

Yet a further object of one embodiment of the invention is to improve users safety by eliminating electric controls.

Yet a further object of the present invention is to provide a bed mechanism which maintains the user's position near the head of the bed, whether the bed head portion is horizontal or sloped.

The present invention achieves the above objects by providing an articulating bed frame, comprising a stationary base frame having a head end, a foot end, and opposed longitudinal members connecting the same, an articulated moving upper frame mounted on a carriage, having leg support portions and upper body support portions articulated to each other and supported on the carriage traveling in channels attached to the bed frame for longitudinal shifting of the support portions relative to the base frame and a mattress-supporting body attached to the upper frame, the mattress-supporting body being divided into at least a first portion including a body support sub-portion, a thigh support sub-portion and a lower leg support sub-portion, and a second head support portion, wherein the articulated movable frame is connected to linkages causing displacement of the head-support portion, at the neck area of the user, linearly and normal relative to the plane of the first portion.

In a most preferred embodiment of the present invention there is provided an articulating bed frame wherein pneumatic controls are provided for the drive.

In U.S. Pat. No. 6,088,853 and corresponding European Application 98107587.2 published as EP 0884011 there is described and claimed a slatted base for a bed having a frame and having a plurality of elements which are connected to one another in an articulated manner, at least one element being pivotable in relation to the or every other element. As will be noted, however, a major characterizing feature defined in said patent is expressed in element d of claim 1 which reads as follows: “the pivotable element is connected to the frame by at least one coupling member so that when said pivotable element is pivoted, a free end of said pivotable element can be moved upwards and downwards in essentially in the vertical direction only”.

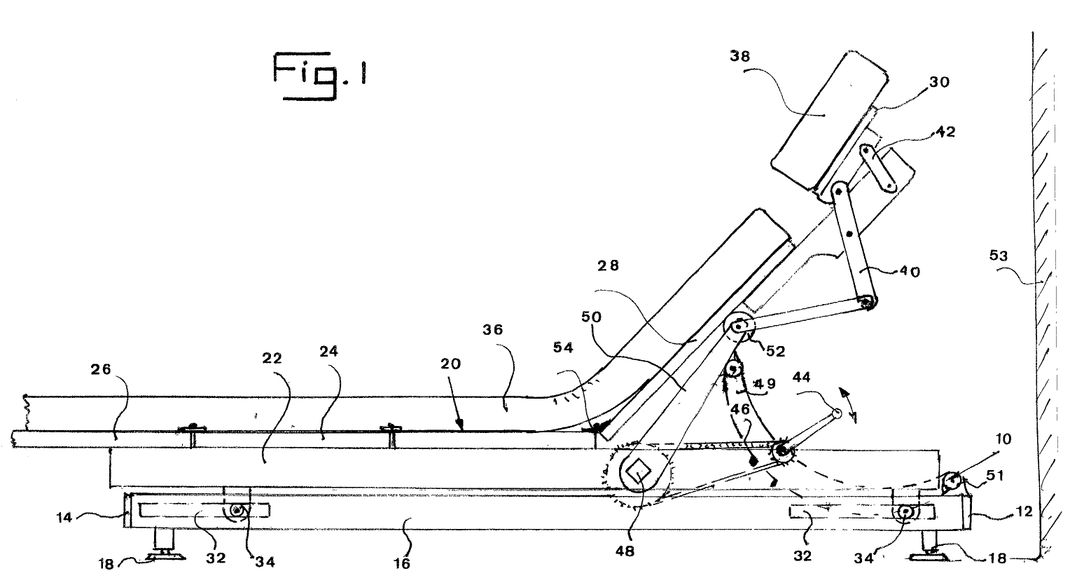

This feature is emphasized also in column 1 lines 39-47 of the US Patent and is specifically explained and described with reference to FIG. 1 in column 3 lines 23-27 in which the following description appears: “the element 22 to be pivoted—that is to say the top element—is connected on both sides thereof to the frame 21 via a coupling member 31 in each case. This ensures that, when the element 22 is pivoted, a free-end 32 of the element 22 is moved upwards and downwards solely in the vertically direction”.

In contradistinction the articulated bed of the present invention was engineered to solve a different problem and is specifically and intentionally provided with linkages causing displacement of said head support portion, at the neck area of the user, linearly and normal relative to the plane of said first portion.

Yet further embodiments of the invention will be described hereinafter.

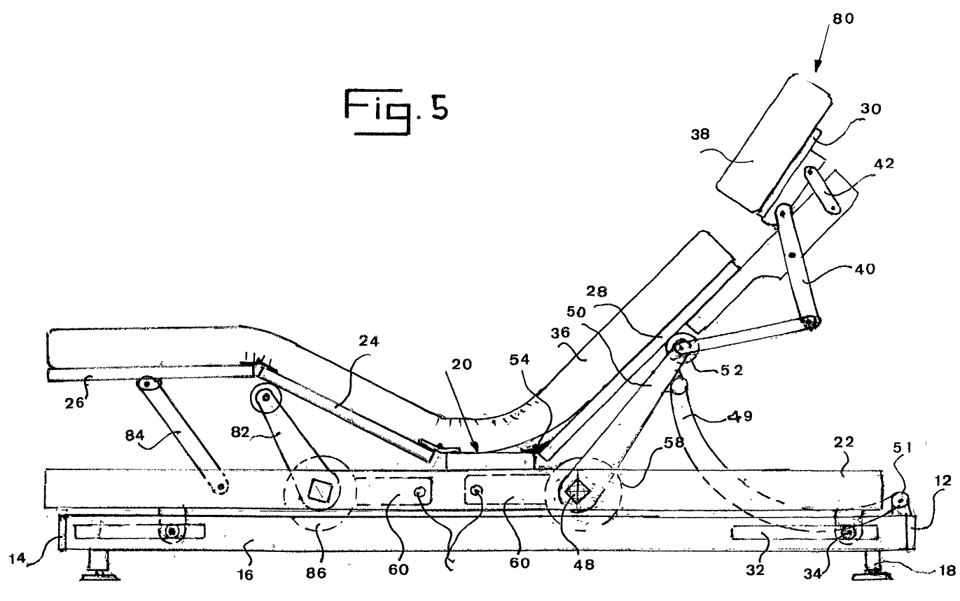

One of the advantages of the linkage design which will be illustrated with reference to FIG. 4 is that all parts of the linkage during its operation always remains within the boundaries of the bed frame. This is advantageous because the fixed base of the bed can be positioned abutting the wall at the head of the bed, without concern that bed adjustments will damage the wall.

With regard to the carriage supporting the upper frame, the provision of wheels is advantageous for easing movement, but it is of course possible to use low-friction plastic pads made of Acetal, nylon or Teflon instead of these wheels.

The subject of electrical safety is in one embodiment of the invention solved by the use of pneumatic controls. While a satisfactory degree of safety could be achieved by using 24 volt controls, nevertheless as matters of safety are often judged perceptively, the pneumatic control will be a feature that attracts users and hospital decision makers despite some cost increase involved thereby.

Furthermore, the 220 volt ac motor normally used is provided with an automatic current stoppage device enabling current flow only during operation of the motor.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regards no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a side elevational view of a preferred embodiment of the bed frame according to the invention, as shown with its head portion raised;

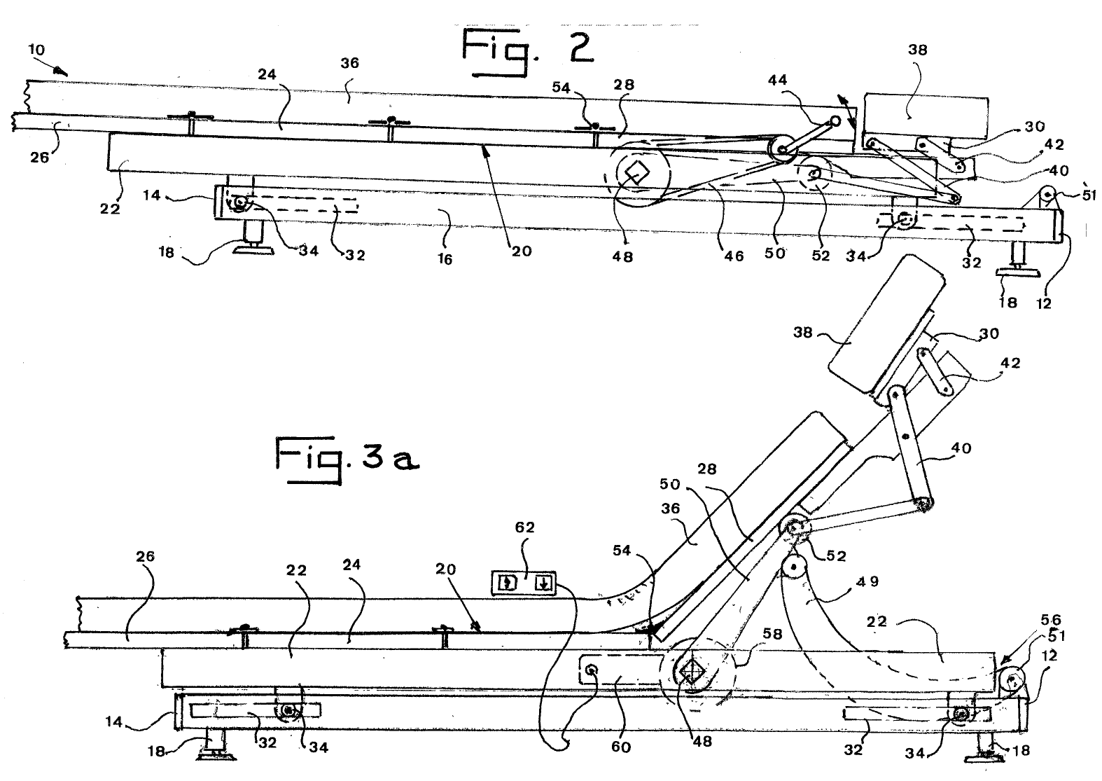

FIG. 2 is as FIG. 1, with the head portion lowered;

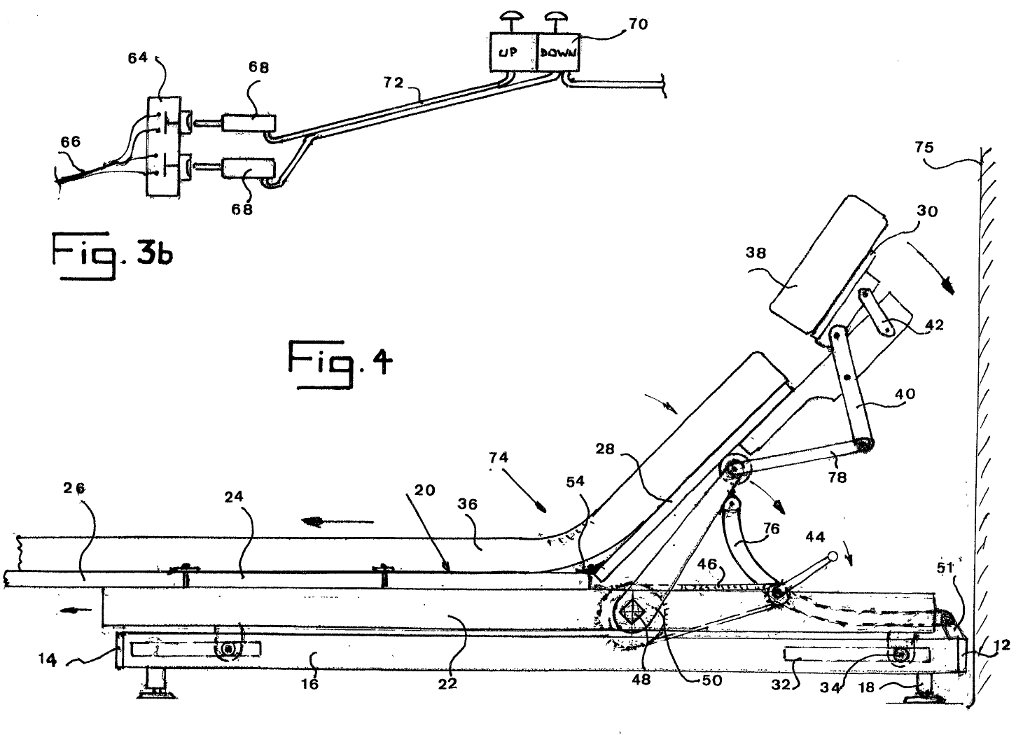

FIG. 3a is a side elevational view of a bed provided with a first electric drive;

FIG. 3b is a diagrammatic view of pneumatic controls for the electric drive;

FIG. 4 is a side elevational view of an embodiment provided with automatic carriage movement;

FIG. 5 is a side elevational view of an embodiment provided with two electric drive units;

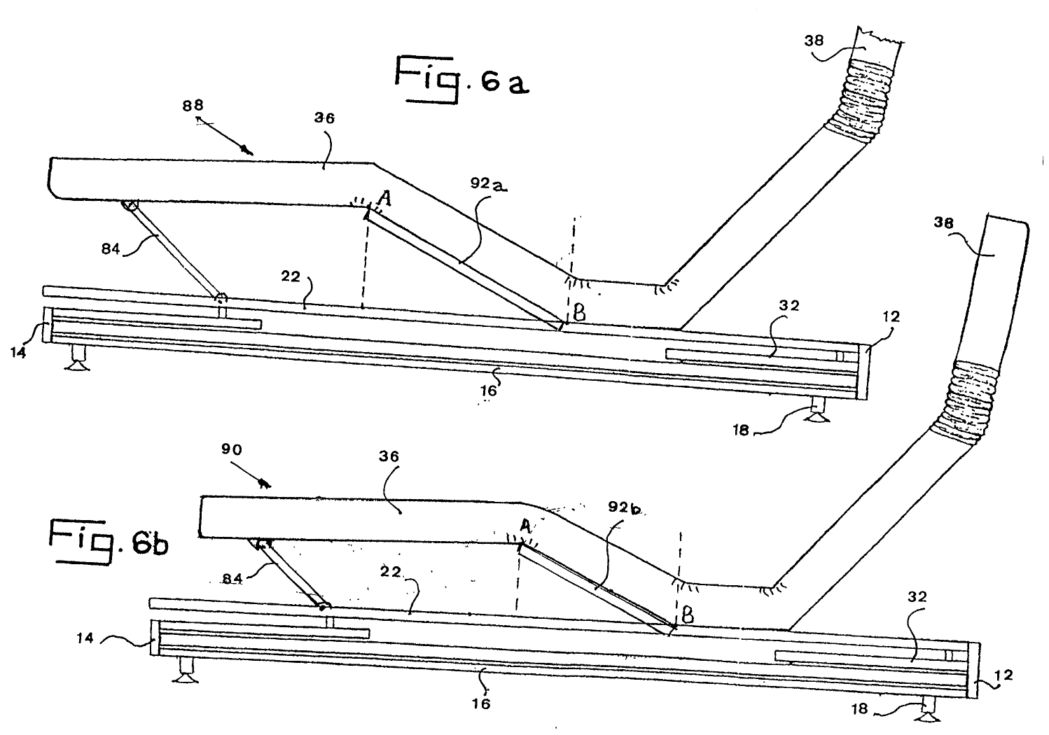

FIGS. 6a and 6b are simplified views of bed frames customized for patients of different heights;

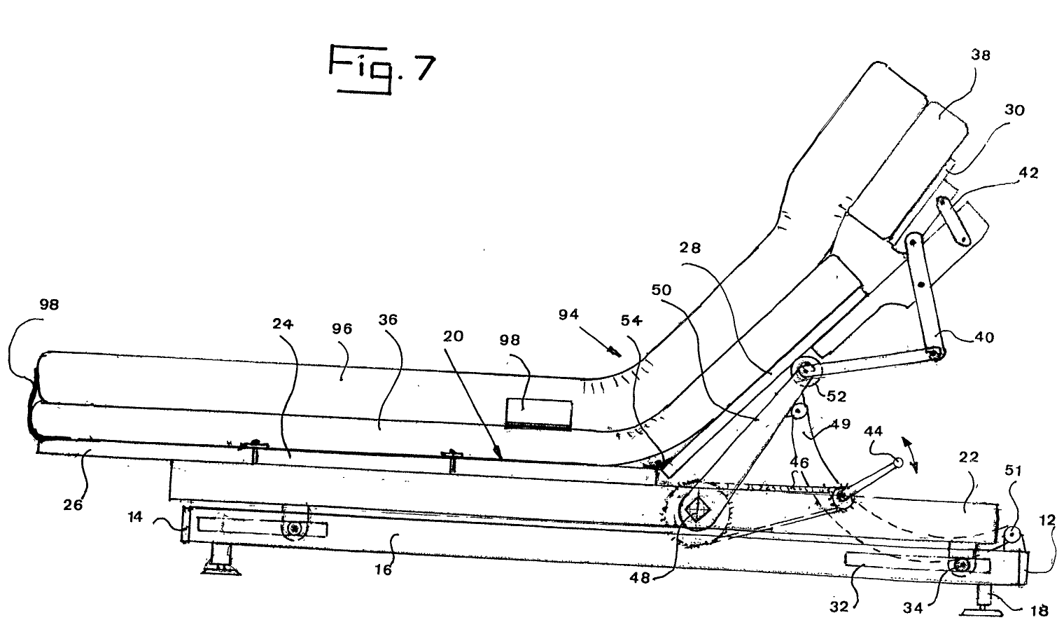

FIG. 7 is a side elevational view of a bed provided with mattress retention means,

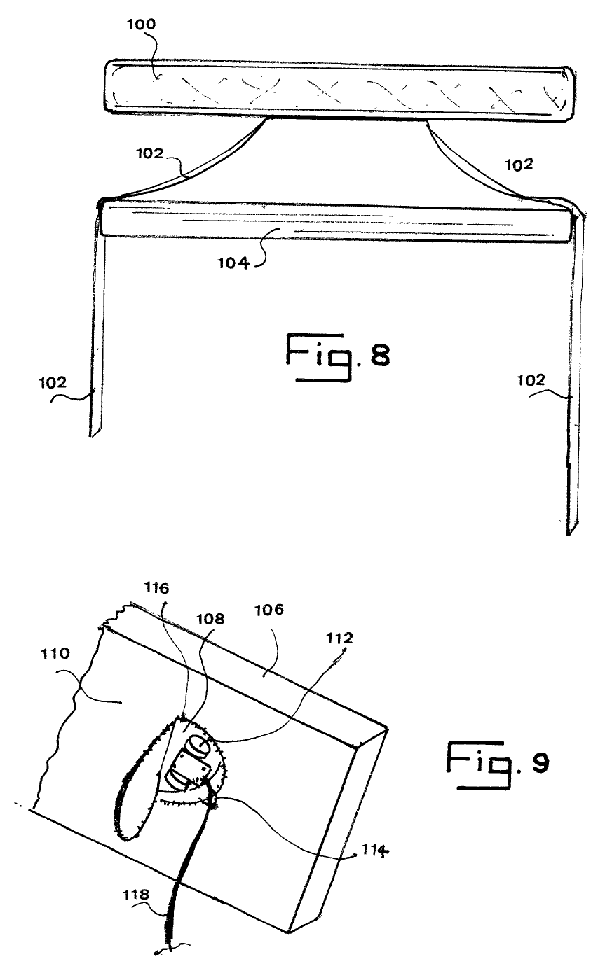

FIG. 8 is a schematic end view of mattress attachment means, the mattress being shown for illustrative purposes suspended above the mattress support body; and

FIG. 9 is a perspective upward-looking view of a massage unit inserted in a mattress support body.

There is seen in FIGS. 1 and 2 an articulating bed frame 10.

A stationary base frame has a head end 12, a foot end 14, and opposed longitudinal members 16 connecting the same. Four feet 18 are attached to the members 16, one near each frame corner.

An articulated moving upper frame 20 is mounted on a carriage 22. The upper frame has leg support portions 24, 26 and upper body support portions 28, 30 articulated to each other. The carriage 22 travels in channels 32, allowing longitudinal shifting of the support portions 24-30 relative to the base frame 12-16. In the present embodiment the channels 32 are stationary and rigidly attached to the longitudinal members 16, while the carriage 22 is provided with wheels 34 which run in the channels 32. Clearly, this arrangement could be reversed if the carriage were to carry the channels and the wheels were fixed to the stationary base frame. Also, the wheels 34 could be replaced by low-friction slide pads.

Raising the body portion 28 causes the carriage 22 to be displaced in the direction of the head end 12, thus keeping the patient near the wall 53 at the head of the bed and preventing unnecessary projection of the carriage 22 at the foot of the bed.

Lowering the body portion 28 causes the carriage 22 to be returned in the direction of the foot end 14. This is achieved by use of the curved link 49 which is pivoted to a fixed arm 51 attached to the head end 12. This provides the extra space needed by the user when in the horizontal position.

A flexible mattress-supporting body 36-38 is attached to the upper frame 20. The mattress-supporting body 36-38 is divided into at least a first portion 36 including a body support sub-portion, a thigh support sub-portion and a lower leg support sub-portion, and a second head support portion 38.

The articulated movable upper frame 20 is connected to linkages 40, 42 causing displacement of the head-support portion 30 linearly and normal relative to the plane of the first portion 28. In the “up” position seen in FIG. 1 the head rest 30 is at a small angle to the body support portion 28. In the “down” position seen in FIG. 2 the head rest 30 is nearer the body support portion 28, about parallel thereto and slightly higher than the body portion 28, having undergone a first displacement from a flat position (not shown) in which bodies 36 and 38 are adjacent and co-planar to the position shown in FIG. 2 in which head portion 38 has been displaced linearly away from the body portion 38 and normal thereto. If a different orientation is desired, one of the two links 40, 42 connected to the head support portion 30 can be replaced with a link slightly larger or smaller.

In the present embodiment the movement is manually powered by means of a crank 44 and chain or toothed belt drive 46, this being suitable for low cost hospital use. Operation of the crank 44 in an anti-clockwise direction causes anti-clockwise rotation of the shaft 48 and arm 50. A rubber roller 52 at the arm extremity presses on the lower face of the body support section 28 which is hinged at its lower edge 54, thus revolving the body support section 28 to its “up” position.

For home use where the patient may need to operate the mechanism, the following embodiment (FIG. 3a) will be more suitable.

With regard to the rest of the figures, similar reference numerals have been used to identify similar parts.

FIG. 3a shows an articulating bed frame 56 similar to the bed frame 10 described with reference to FIGS. 1 & 2. The body portion 28 is hingedly supported at its lower edge 54 and may be pivotally displaced, as seen in FIG. 1, from a horizontal position as seen in FIG. 2, and returned to the horizontal position by a first reversible drive 58. The embodiment shown shows a drive unit containing a quiet reversible geared electric motor 60. 24 Volt electric controls 62 are provided. The advantage of electrical operation is more than a matter of saving time and effort; electrical operation allows the patient him/herself to make desirable changes in bed configuration. For this reason such a bed is suitable for an invalid living at home or in a nursing home where an attendant may be unavailable for this purpose.

Hospital management particularly concerned about safety can order the use of pneumatic controls shown in FIG. 3b for the electric drive 58 seen in FIG. 3a.

The electric switches 64, e.g. push-buttons, are positioned well out of reach of the patient, for example underneath the bed. The switches 64 are operated by miniature air cylinders 68, advantageously of the spring return type. The patient is provided with push-button air valves 70, which activate the cylinders 68 through flexible connector tubing 72.

Pneumatic power is nearly always available in hospitals. In the present embodiment nothing electrical comes into contact with the patient.

Seen in FIG. 4 is an articulating bed frame 74, generally similar to the bed frame 10 seen in FIG. 1.

Raising the body portion 28 causes the carriage 22 to be displaced in the direction of the head end 12, thus keeping the patient near the wall 75 at the head of the bed and preventing unnecessary projection of the carriage 22 at the foot of the bed.

Lowering the body portion 28 causes the carriage 22 to be returned in the direction of the foot end 14. This is achieved by use of the curved link 76 which is pivoted to a fixed arm 78 attached to the head end 12. This provides the extra space needed by the user when in the horizontal position.

It is important to note that whatever the position of the bed, the mechanism never projects outward beyond the fixed head end 12. Thus there is no danger of wall damage at the head of the bed, or obstruction by the wall to the free operation of the mechanism 78.

Referring now to FIG. 5, there is depicted an articulating bed frame 80 which is generally similar to the articulating bed frame 56 seen in FIG. 3a. A second reversible electric drive 86, acting to turn arm 82 in a clockwise direction, provides the power for raising the thigh portion 24, which through linkage 84 also raises the lower leg portion 26. In this preferred embodiment both motors 60 are interconnected and each is provided with a simple clutch release button 62 enabling both arms 50 and 82 to return the bed to its horizontal orientation. Thus as shown the leg portion 24-26 is hingedly supported and is shown pivotally displaced from its horizontal position. When the button 62 is operated to return the arm 82 in an anti-clockwise direction to its original position, the arm 82 allows the leg portion 24-26 to return by gravity to its horizontal state.

No movement of the carriage 22 takes place during movement of the leg portion 24-26.

FIGS. 6a and 6b show articulating bed frames 88 90 in simplified form. The thigh portion 92a, 92b has been customized to adapt each bed for a particular patient.

In FIG. 6a a large thigh-portion support plate 92a is intended for a tall patient, whereas the bed frame seen in FIG. 6b having a short thigh-portion support plate 92b is intended for a short patient. If patient changes are expected to be frequent, an adjustable size plate (not shown), comprising two overlapping sectors, could be used.

FIG. 7 illustrates an adjustable bed 94 comprising an articulating bed frame similar to 10 seen in FIG. 1 and further comprising a one-piece upper mattress 96 resting on the mattress-supporting body 36-38.

As in FIG. 1, linkages 40-42 are arranged to linearly displace the head support portion 38 from the first portion of the mattress-supporting body 36 and then to elevate and tilt both of the portions 36-38, whereby the head-support portion 38 continues to provide support to an upper area of the mattress 96 during the tilting thereof.

Attached VELCRO® strips 98 are provided for interconnecting the mattress 96 and the mattress-supporting body 36, to prevent shifting when the mattress support body is bent.

Seen in FIG. 8 is a mattress 100 for use in an adjustable bed. For illustrative purposes the mattress 100 is shown suspended above the mattress-support body 104; in practice the mattress of course rests directly on the mattress-support body 104. The mattress 100 is provided with flexible strips 102 extending from the side surfaces thereof, the strips 102 being of a length to enable the same to extend under the mattress and to attach to the mattress-support body 104 without interfering with the placement of a sheet on the mattress.

Referring now to FIG. 9, there is depicted a detail of an adjustable bed configured to prevent the development of bed sores in long-term patients.

The mattress-support body 106 is further provided with at least one, and preferably three openable and closable pockets 108 on a major face 110. An electrically-driven massage unit 112 is provided for insertion into the pocket 108. A small aperture 114 remaining along the closure seam 116 of the pocket allows passage therethrough for an electric cable 118 connected to the massage unit 112. Said electrically-driven massage unit 112 is also connected to an automatic stop-voltage device (not shown) whereby there is current only during operation of the massage unit

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An articulating bed frame, comprising:
a) a stationary base frame having a head end, a foot end, and opposed longitudinal members connecting the same;
b) an articulated moving upper frame mounted on a carriage, having leg support portions and upper body support portions articulated to each other and supported on said carriage traveling in channels attached to said bed frame for longitudinal shifting of said support portions relative to said base frame; and
c) a mattress-supporting body attached to said upper frame, said mattress-supporting body being divided into at least a first portion including a body support sub-portion, a thigh support sub-portion and a lower leg support sub-portion, and a second head support portion, wherein said articulated movable frame is connected to linkages causing displacement of said head-support portion, at the neck area of the user, linearly and normal relative to the plane of said first portion.

2. An articulating bed frame according to claim 1, wherein said body portion is hingedly supported and may be pivotally displaced from a horizontal position and returned to said position by a first reversible drive.

3. An articulating bed frame according to claim 2, wherein raising said body portion causes said carriage to be displaced in the direction of said head end and lowering said body portion causes said carriage to be returned in the direction of said foot end.

4. An articulating bed frame according to claim 1, wherein said leg portion is hingedly supported and may be pivotally displaced from a horizontal position and returned to said position by a second reversible drive.

5. An articulating bed frame according to claim 2, wherein pneumatic controls are provided for said drive.

6. An articulating bed frame according to claim 1, wherein said thigh portion can be length adjusted to customize the bed for a particular patient.

7. An adjustable bed comprising an articulating bed frame according to claim 1, and further comprising a one-piece upper mattress resting on said mattress-supporting body, the arrangement being such that said linkages are arranged to linearly displace said head support portion from said first portion of said mattress-supporting body and then to elevate and tilt both of said portions, whereby said head-support portion continues to provide support to an upper area of said mattress during the tilting thereof.

8. An adjustable bed according to claim 7, wherein attached VELCRO® strips are provided for interconnecting said mattress and said mattress-supporting body.

9. An adjustable bed according to claim 7, wherein said mattress is provided with flexible strips extending from the side surfaces thereof, said strips being of a length to enable the same to extend under said mattress and to attach to upper surfaces of said mattress-support body without interfering with the placement of a sheet on said mattress.

10. An adjustable bed according to claim 7 wherein said mattress-support body is further provided with at least one openable and closable pocket on a major face, and at least one electrically-driven massage unit is provided for insertion into said pocket, a small aperture remaining along the closure seam of said pocket to allow passage therethrough for an electric cable connected to said massage unit.
